(19) United States
(12) Patent Application Publication
(10) Pub. No.: US 2006/0253662 A1
(43) Pub. Date: Nov. 9, 2006

(54) Retry cancellation mechanism to enhance system performance

(76) Inventors: Brian Mitchell Bass, Apex, NC (US); James Norris Dieffenderfer, Apex, NC (US); Thuong Quang Truong, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/121,121

(22) Filed: May 3, 2005

(51) Int. Cl. G06F 13/00; G06F 12/00

(52) U.S. Cl. 711/154; 711/118

(57) ABSTRACT

A method, an apparatus, and a computer program are provided for a retry cancellation mechanism to enhance system performance when a cache is missed or during direct memory access in a multi-processor system. In a multi-processor system with a number of independent nodes, the nodes must be able to request data that resides in memory locations on other nodes. The nodes search their memory caches for the requested data and provide a reply. The dedicated node arbitrates these replies and informs the nodes how to proceed. This invention enhances system performance by enabling the transfer of the requested data if an intervention reply is received by the dedicated node, while ignoring any retry replies. An intervention reply signifies that the modified data is within the node's memory cache and therefore, any retries by other nodes can be ignored.

### CROSS-REFERENCED APPLICATIONS

This application relates to co-pending U.S. patent application entitled “DISTRIBUTED ADDRESS ARBITRATION SCHEME FOR SYMMETRICAL MULTIPROCESSOR SYSTEM” (Docket No. RPS920040104US1), filed on the same date.

### FIELD OF THE INVENTION

The present invention relates generally to a multi-processor system, and more particularly, to a retry cancellation mechanism to enhance system performance.

### DESCRIPTION OF THE RELATED ART

In a multi-processor system there are three main components: the processing units with their cache, the input/output (IO) devices with their direct memory access engine (DMA), and the distributed system memory. The processing units execute instructions. The IO devices handle the physical transmission of data to and from memory using the DMA engine. The processing units control the IO devices by issuing commands from an instruction stream. The distributed system memory stores data. As the number of processing units and system memory size increases, the processor systems may need to be housed on separate chips or nodes.

The separate nodes must be able to communicate with one another to access all of the distributed memory within the multi-processor system. Arbiters are designed to control command flow and the transmission of data between separate nodes within a multi-processor system. Processing units, I/O devices, distributed system memory, and arbiters are the main components of a multiple node multi-processor system.

FIG. 1 depicts a block diagram illustrating a typical 8-way-in-four-nodes multi-processor system 100. Accordingly, there are four separate nodes and four pathways to transfer data. For example, node0 102 can transmit data to node1 114 or receive data from node3 138. Each node is connects to two adjacent nodes. Each node also contains four main components: a portion of distributed system memory, processing units with its caches, an I/O device with DMA engines, and an arbiter. Specifically, Node0 102 contains: two processing units, PUO 108 and PUO 110, an I/O device, I/O 0 106, a group of memory devices, Memory0 104, and an arbiter, Arbiter0 112. Node1 114 contains: two processing units, PU1 122 and PU1 120, an I/O device, I/O 1 118, a group of memory devices, Memory1 116, and an arbiter, Arbiter1 124. Node2 126 contains: two processing units, PU2 132 and PU2 134, an I/O device, I/O 2 130, a group of memory devices, Memory2 128, and an arbiter, Arbiter2 136. Node3 138 contains: two processing units, PU3 144 and PU3 146, an I/O device, I/O 3 142, a group of memory devices, Memory3 140, and an arbiter, Arbiter3 148.

Each group of distributed system memory, 104, 116, 128, and 140 store data. For example, memory0 104 contains memory locations 0→A, memory1 116 contains memory locations A+1→B, memory2 128 contains memory locations B+1→C, and memory3 140 contains memory locations C+1→D. One problem in these multiple node multi-processor systems is that Node0 102 may need data that is stored in another node and Node0 102 has no idea where the necessary data is located. Therefore, there must be a method of communication between the nodes in the system. The arbiters, 112, 124, 136, and 148 control the communication between the nodes in this system. In addition, the arbiters communicate with the processing units within the same node to store and to retrieve the requested data.

For example, Node0 102 may need a specific packet of data that is not stored in the address range of its memory 104. Therefore, Node0 102 must search the other nodes within the system to look for this data. Processing unit 108 sends a request for a specific packet of data to arbiter0 112. This request contains an address range that corresponds to the requested data. In turn, arbiter0 112 prepares a request for the data and sends it to the other nodes, 114, 126, and 138, in the system. The arbiters, 124, 136, and 148, receive this request and one of them becomes a dedicated node, based upon the requesting address range. This dedicated node sends out a reflected (snoop) command to all nodes in the system and its own caches and system memory. Each node's processing units' caches and system memory search for the data in memory and send back to the dedicated arbiter the results of their search. The dedicated arbiter interprets the search results and determines the most accurate data packet with the specific address value. The requested data is then sent to the requesting node. Subsequently, arbiter0 112 sends the data packet to processing unit 108 that requested the data. This example only provides an overview of a DMA transfer or a cache missed access. The following discussion describes this method in further detail.

FIG. 2 depicts a block diagram illustrating a conventional example of cache missed or direct memory access through a four-node multi-processor system 200. Node0 102, Node1 114, Node2 126, and Node3 138 signify the nodes in FIG. 1 without the internal components. There are five command phases on the ring for this type of operation. The first phase is an initial request, which results from a DMA request or a cache miss in the requesting node. The requesting node sends the initial request to a dedicated arbitration node, which handles the operation based upon the requesting address range. The second phase is a reflected command, wherein the dedicated node broadcasts the request to all nodes in the system. The reflected command is produced by the arbiter of the dedicated node. In response to the reflected command, the nodes search for the requested data in their caches or system memory. The third phase is a reply by all of the processing units within a node, called a snoop reply. The fourth phase is the combined response, which is the combined result of all the snoop replies. The combined response is sent out by the dedicated node after it has received all of the snoop replies. This response informs the nodes how to proceed. The fifth phase is the data transfer. The node with the data is able to send the information to the requesting node using information from the original reflected command and the combined response. Depending on implementation, in the case of a cache intervention, data can be transferred to the requesting node before the combined response phase.

FIG. 2 illustrates the conventional method to handle a DMA request or a cache miss. Node0 102 needs a packet of data. This could be the result of a DMA request or the fact that the data is not located in its system memory or caches on this node. Node1 114 is the dedicated arbitration node based upon the requesting address range. The dedication arbitration node could be the requesting node but in this example it is not. Node0 102 sends an (10) initial request to Node1 114 with the memory range address of the requested data. Node1 114 sends out a (20) reflected command to the rest of the nodes. Node0 102, Node1 114, Node2 126 and Node3 138 snoop (search) their caches and system memory.

After the nodes have snooped their caches and system memory, they send out a snoop reply. In this example, Node2 126 is busy and cannot snoop its caches. Therefore, Node2 126 sends a (31) snoop reply with a retry, which means that the original request needs to be resent at a later time. For this embodiment, a snoop reply with a retry has the retry bit set. Node3 138 has the accurate, updated data and sends a (32) snoop reply with intervention. The intervention bit signifies that Node3 138 has the modified (most updated) data. In this system, only one node has the modified data. For this implementation, node3 138 knows that it has the modified data because of a cache state identifier. This cache state identifier indicates the status of the data. The cache state identifier can indicate whether the data is modified, invalid, exclusive, etc. Node0 102 sends a (33) snoop reply (null) because it is the requesting node and does not have the data. Simultaneously, Node1 114 snoops its caches to search for the correct data and sends the reflected command to its memory.

The arbiter of Node1 114 collects all of the snoop replies from all of the nodes. It sees that an intervention bit and a retry bit are set. The arbiter orders a (41) combined response retry, which indicates that this request must start over because one node was busy and unable to snoop its caches. The arbiter of Node1 114, depending upon implementation, may negate the intervention bit of the snoop reply from Node3 138 when creating the combined response. Any time that the dedicated arbiter sees a retry bit, it sends out a combined response retry. This process is inefficient because Node3 138 has the accurate, updated data. Even though Node3 138 set the intervention bit, Node1 114 ignored the intervention and created a retry because this is normal protocol. When Node0 102 sees a (41) combined response with a retry it sends its original request out to the ring again. This described process is implementation specific and can be accomplished through other methods.

A repeating retry can cause a live-lock situation or degradation on system performance. A node sends a snoop reply with the retry bit set in multiple situations. A full queue or a refresh operation causes a node to send a snoop reply with a retry. A node may also send a retry because it is just to busy with a lot of queuing or requesting. Accordingly, a retry may be sent out even though the node does not have anything to do with the request. In this case Node3 138 has the requested information, but the request must start over because Node2 126 was busy. In other examples, the dedicated arbitration node would send out a combined response of retry if the requesting node is busy even though it is obvious that the requesting node does not have the requested data, but has sent out a reply with the retry bit set because one of its units was busy. The dedicated node, node1 114 can also assert the retry bit internally, which can lead to a combined response with a retry.

### SUMMARY

The present invention provides a method, apparatus, and computer program product for a retry cancellation mechanism to enhance system performance when a cache is missed or during direct memory access in a multi-processor system. In a multi-processor system with a number of independent nodes, the nodes must be able to access memory locations that reside on other nodes. If one node needs a data packet that it does not contain in its memory or caches, then it must be able to search for this data in the memory or caches of the other nodes.

If a specific node needs a data packet it makes an initial request that provides the corresponding address for the requested data. One of the nodes in the system sends out a reflected command to the rest of the nodes in the system. All of the nodes search their memory caches for the corresponding address. Each node sends a reply that indicates the result of the search. The node that created the reflected command synthesizes these replies and sends out a combined response that informs each node how to proceed. This invention enhances system performance by enabling the transfer of data even if a retry reply is received as long as an intervention reply is also received. An intervention reply signifies that modified data is within a specific node's memory cache. Previously, a retry reply from any node in the system would force a combined response of a retry, which means that this whole process would have to start over at a later juncture.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram illustrating a typical 8-way (8 processors in the system) in 4 nodes multi-processor system;

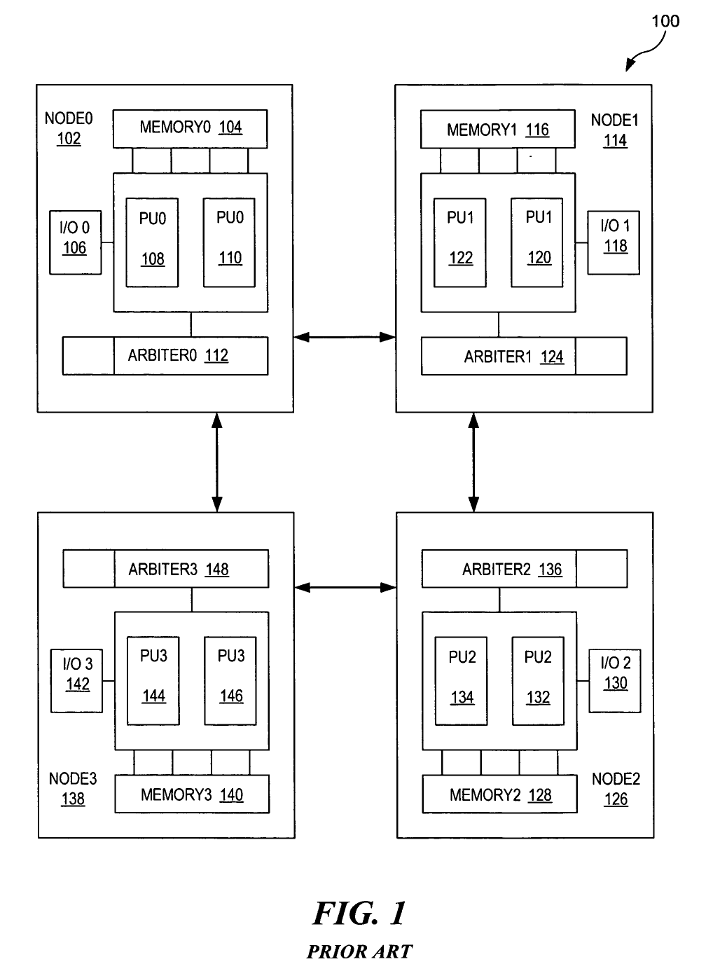

FIG. 2 is a block diagram illustrating a conventional example of cache missed or direct memory access through a 4 node multi-processor system;

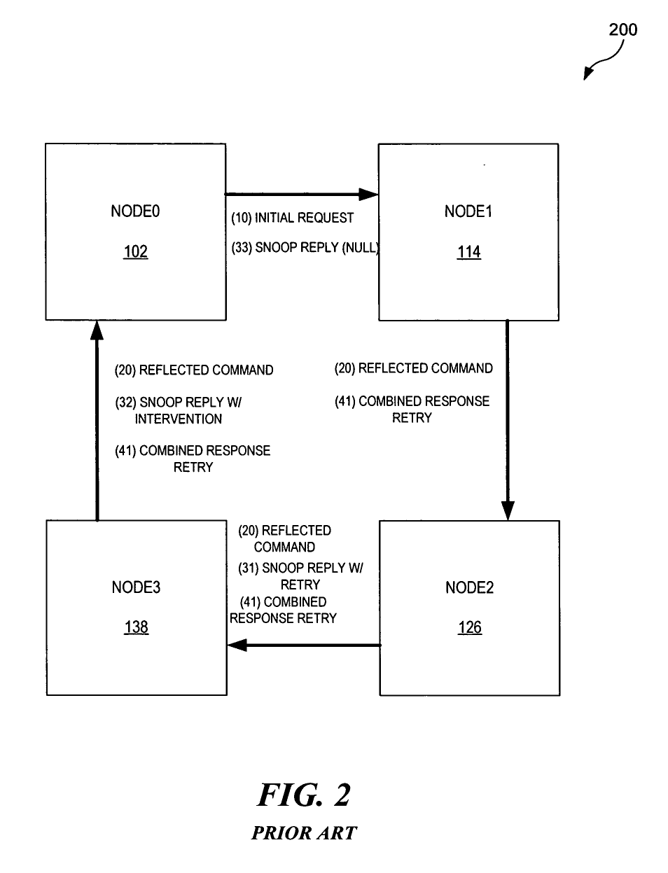

FIG. 3 is a block diagram illustrating a modified example of cache missed or direct memory access through a 4 node multi-processor system; and

FIG. 4 is a flow chart depicting the modified process of cache missed or direct memory access in a multi-processor system.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

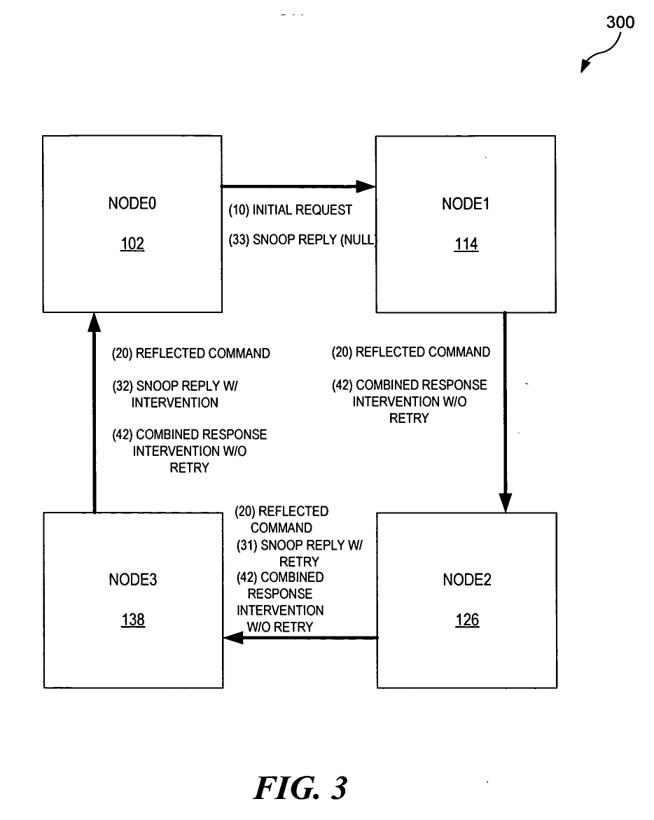

FIG. 3 depicts a block diagram illustrating a modified example of cache missed or direct memory access through a four-node multi-processor system 300. This modified method of a cache missed or a direct memory access involves canceling the retry bit if the intervention bit is set. If the intervention bit is set, then the dedicated arbitration node sends out a clean combined response, which indicates that the data can be transferred. The dedicated arbitration node does not create a retry combined response if at least one node has the accurate, updated data within its caches and a reply with an intervention bit set was sent.

FIG. 3 illustrates the modified method to handle a DMA request or a cache missed request. Node0 102 needs a packet of data. This could be the result of a DMA request or the fact that the data is not located in its memory cache. Node1 114 is the dedicated arbitration node based upon the requesting address range. Node0 102 sends an (10) initial request to Node1 114 with the memory range address of the requested data. Node1 114 sends out a (20) reflected command to the rest of the nodes identifying the memory address range. Based upon this address range, Node0 102, Node1 114, Node2 126 and Node3 138 snoop their memory caches.

After the nodes have snooped their caches and system memory, they send out a snoop reply. In this example, Node2 126 is busy and cannot snoop its caches. Therefore, Node2 126 sends a (31) snoop reply with a retry, which means that the snoop needs to be retried. Node3 138 has the accurate, updated data and sends a (32) snoop reply with intervention. The intervention bit signifies that Node3 138 has the modified data. Node0 102 sends a (33) snoop reply (null) because it is the requesting node and does not have the data. Simultaneously, Node1 114 snoops its caches to search for the correct data.

The arbiter of Node1 114 collects all of the snoop replies from all of the nodes. It sees that an intervention bit and a retry bit are set. Node1 114 negates the retry bit because Node3 138 set the intervention bit. Node3 138 has the correct data, so there is no need to retry the data request. Node1 114 sends out the (42) combined response without a retry and with the intervention bit set. This response indicates that the data was found and the operation does not need to be restarted. This combined response also enables the requested data from Node3 138 to be transferred to Node0 102, and allows all of the nodes to update their caches with the correct data if necessary. The requesting node and the other snoopers in the system can update their caches by changing the cache state identifier or replacing the data, if that is indicated in the combined response and the specific node deems it necessary.

This modified method is a clear improvement over the prior art because system performance is enhanced by avoiding multiple retries. Performance should not be degraded simply because one node is busy if the correct data can be provided elsewhere. In high traffic times, multiple retries can dramatically slow down multiple node multi-processor systems.

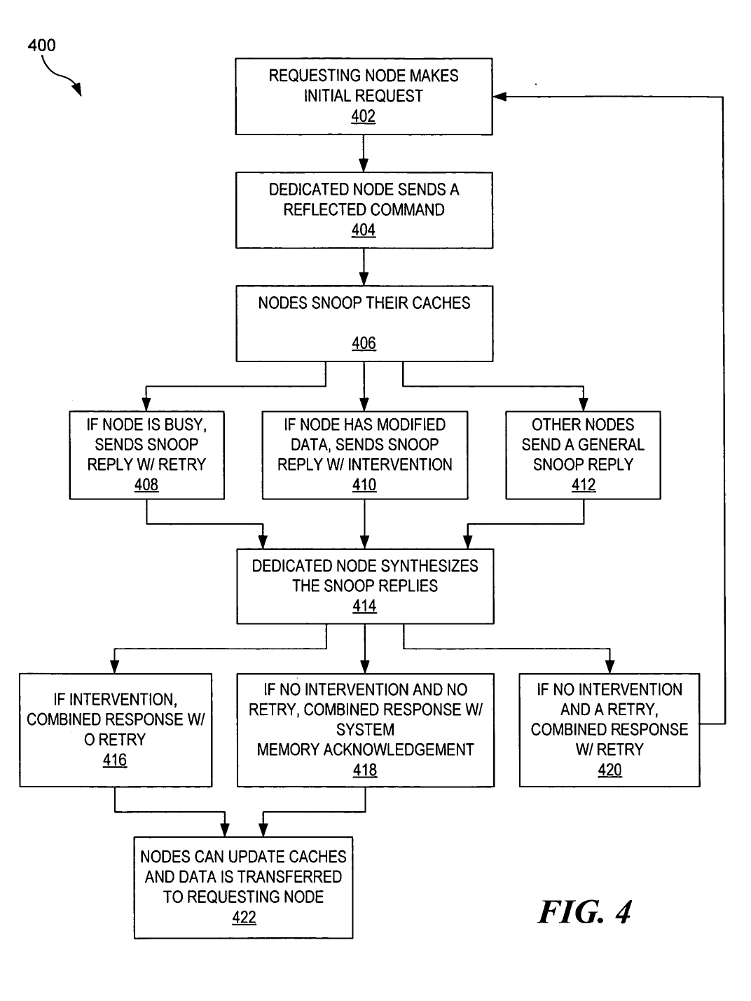

FIG. 4 is a flow chart 400 depicting the modified process of cache missed or direct memory access in a multi-processor system. When a node requires data that is not in its caches, it makes an initial request 402. The initial request travels to the dedicated node and the dedicated node sends a reflected command to all of the nodes in the system 404. The nodes in the system snoop their caches and system memory to look for the requested data 406. If a specific node is busy, then it sends a snoop reply with a retry 408. If a specific node has the modified data, then it sends a snoop reply with an intervention 410. Other nodes send a general snoop reply 412. The general snoop reply could indicate that the node does not have the requested data or that the requested data may not be modified.

The dedicated node receives the snoop replies and synthesizes these replies 414. In other words, the dedicated node combines all of the snoop replies and determines which combined response to send out. If there was a snoop reply with an intervention, then the dedicated node sends a combined response without a retry 416. In response to the combined response without a retry, the nodes can update their caches and the requested data is transferred to the requesting node 422. If there were no snoop replies with an intervention or a retry, then the dedicated node sends a combined response indicating which system memory has the data 418. This combined response indicates that the data was not found by any snoopers in their caches and the memory on the dedicated node provides the requested data. In response to this combined response, the nodes can update their caches and the resultant data is transferred to the requesting node 422. If there was a snoop reply with a retry and there were no snoop replies with an intervention, then the dedicated node sends a combined response with a retry 420. Following a combined response with a retry, the process must restart with an initial request 402.

It is understood that the present invention can take many forms and embodiments. Accordingly, several variations of the present design may be made without departing from the scope of the invention. The capabilities outlined herein allow for the possibility of a variety of programming models. This disclosure should not be read as preferring any particular programming model, but is instead directed to the underlying concepts on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method for handling memory access in a multi-processor system containing a plurality of independent nodes, comprising:
requesting at least one packet of data with a corresponding memory address by a requesting node of the plurality of nodes;
distributing the requested memory address to the plurality of nodes by a dedicated node of the plurality of nodes;
producing at least one reply comprising an intervention reply, a busy reply, or a null reply by each of the plurality of nodes;
synthesizing the plurality of replies by the dedicated node of the plurality of nodes; and
providing the requested data packet to the requesting node in response to at least one intervention reply, regardless of whether a busy reply was produced by a node.

2. The method of claim 1, wherein memory access comprises cache missed memory access or direct memory access.

3. The method of claim 1, wherein the dedicated node is selected based upon the requested data's memory address range.

4. The method of claim 1, wherein the distributing step further comprises each node of the plurality of nodes searching through its caches.

5. The method of claim 4, wherein the producing step comprises the substeps of:
producing the intervention reply if the requested data is modified in its caches;
producing the retry (busy) reply if the node is unable to search its memory or caches; and
producing the null reply if the requested data is not in its caches.

6. The method of claim 1, wherein the providing step further comprises sending out a combined response to the plurality of nodes.

7. The method of claim 1, wherein the providing step further comprises ignoring any retry (busy) replies.

8. An apparatus for handling memory access in a multi-processor system comprising:
a plurality of interfacing, independent nodes, wherein each node further comprises:
at least one data transmission module that is at least configured to transmit data to the plurality of modules;
at least one memory that is at least configured to store data; and
at least one processing unit with caches that is at least configured to execute instructions and search its caches; and
at least one arbiter that interfaces each of the plurality of nodes that is at least configured to carry out the steps of:
determining a result of the search of the at least one memory or cache;
producing an intervention reply, a retry (busy) reply, or a null reply in response to the search;
synthesizing the plurality of replies from the plurality of nodes; and
producing a combined response that enables the transmission of data in response to at least one intervention reply, regardless of whether a busy reply was produced.

9. The apparatus of claim 8, wherein memory access comprises cache missed memory access or direct memory access.

10. The apparatus of claim 8, wherein the at least one arbiter comprises a plurality of arbiters wherein one arbiter resides on each node of the plurality of nodes.

11. The apparatus of claim 10, wherein the plurality of arbiters are at least configured to accomplish the steps of:
reflecting a command if the request is in its memory range;
synthesizing all snoop replies from the plurality of nodes; and
sending out the combined response to the plurality of nodes.

12. The apparatus of claim 10, wherein the plurality of arbiters is at least configured to accomplish the steps of:
producing the intervention reply if the requested data is modified in its caches;
producing the retry (busy) reply if the node is unable to search its memory or caches; and
producing the null reply if the requested data is not in its caches.

13. The apparatus of claim 8, wherein the at least one arbiter is at least configured to ignore any retry (busy) replies in response to at least one intervention reply.

14. A computer program product for handling memory access in a multi-processor system containing a plurality of independent nodes, with the computer program product having a medium with a computer program embodied thereon, wherein the computer program comprises:
computer code for requesting at least one packet of data with a corresponding memory address by a requesting node of the plurality of nodes;
computer code for distributing the requested memory address to the plurality of nodes by a dedicated node of the plurality of nodes;
computer code for producing at least one reply comprising an intervention reply, a busy reply, or a null reply by each of the plurality of nodes;
computer code for synthesizing the plurality of replies by the dedicated node of the plurality of nodes; and
computer code for providing the requested data packet to the requesting node in response to at least one intervention reply, regardless of whether a busy reply was produced by a node.

15. The computer program product of claim 14, wherein memory access comprises cache missed memory access or direct memory access.

16. The computer program product of claim 14, wherein the dedicated node is selected based upon the requested data's memory address range.

17. The computer program product of claim 14, wherein the computer code for distributing the requested memory address further comprises, each node of the plurality of nodes searching through its caches.

18. The computer program product of claim 17, wherein the computer code for producing at least one reply comprises the substeps of:
producing the intervention reply if the requested data is modified in its caches;
producing the busy reply if the node is unable to search its memory or caches; and
producing the null reply if the requested data is not in its caches.

19. The computer program product of claim 14, wherein the computer code for providing the requested data packet further comprises sending out a combined response to the plurality of nodes.

20. The computer program product of claim 14, wherein the computer code for providing the requested data packet further comprises, ignoring any retry (busy) replies.
